(19) United States
(12) Patent Application Publication
(10) Pub. No.: US 2014/0108073 A1
(43) Pub. Date: Apr. 17, 2014

(54) SYSTEM AND METHOD FOR POPULATING ASSETS TO A MAINTENANCE MANAGEMENT SYSTEM

(71) Applicants: MARC CASTEL, ORANGEVILLE (CA); CORBIN CHURCH, WESTMOUNT (CA)

(72) Inventors: MARC CASTEL, ORANGEVILLE (CA); CORBIN CHURCH, WESTMOUNT (CA)

(21) Appl. No.: 14/049,134

(22) Filed: Oct. 8, 2013

Related U.S. Application Data
(60) Provisional application No. 61/711,183, filed on Oct. 8, 2012.

(51) Int. Cl. G06Q 10/06

(52) U.S. Cl. CPC G06Q 10/063
USPC 705/7.11

(57) ABSTRACT

An on-boarding computer system is provided that guides a mobile device user through the capture of visual information that identifies assets or physical objects using a mobile device, and optionally tagging of the visual information. This information is sent to a server computer or cloud service that includes one or more tools for mapping the information to a list of asset/physical object records. The server computer includes one or more automated utilities for performing the mapping processes. If these mapping processes do not meet an identification threshold then, a work ticket is created and assigned to one of a pool of human agents to complete the mapping processes. Related computer implemented methods are also provided.

### FIELD

Embodiments described herein relate to the on-boarding of information to a computer system such as a server computer or Internet service, and in particular relates to the on-boarding of information that relates to physical assets or objects.

### INTRODUCTION

Every business must manage the various resources that are critical to their business operations. Large enterprises often make significant investments in implementation of platforms and development of business processes related to resource management. These investments are outside the reach of many small to medium enterprise (SMEs) that constitute ninety-nine percent (99%) of enterprises.

A good example of this is the maintenance of equipment. Maintenance is a critical aspect of any business, in any industry, yet in many cases there is little focus on maintenance until there has been a breakdown. Maintenance related downtime can be very costly to a business, sometimes resulting in significant losses every hour that a key machine is down.

Maintenance departments typically rely on unreliable paper-based information systems that often produce inaccurate, outdated, confusing, or non-existent data, which can be lost or destroyed easily. Moreover, it is often challenging to align and manage a maintenance department's priorities (such as maintaining a machine) with a production department's priorities (such as manufacturing goods).

Computerized maintenance management systems (CMMS) are designed to digitize data and manage a maintenance department's activities such as work orders, scheduling, reporting, inventory, and personnel. However, the proper use of a CMMS is generally fraught with difficulty due to their complex nature, their significant cost, and non-intuitive or confusing workflows, which taken together, may not lead to improved efficiencies or productivities of a maintenance department, nor do they add to a company's bottom line.

A particular problem is that a CMMS may be difficult to setup and use. In particular, it is often time consuming on-boarding a CMMS with all the equipment requiring maintenance. Identifying particular equipment to the CMMS can be difficult. A typical business has many pieces of equipment, and often pieces of equipment that seem identical may be different models. Maintenance requirements may vary depending on the model. Also, the same equipment may have different identifiers depending on the particular distributor, for example. Collecting the information required to populate equipment to the CMMS, and then verifying this information, can be time consuming. This is often the bottleneck that prevents adoption, or full adoption, of a CMMS. The advantages of a CMMS without adoption across an organization may be reduced. Maintenance staff is often required to participate in on-boarding a CMMS but typically they do not complete these tasks because of other priorities, or the information may not be accurate.

In order to populate a CMMS database, a person or team of people generally must gather and input all the asset information into the system (such as for example equipment make, model, serial number, pictures, manuals, warranty information, etc.). The manual data entry of assets and associated information is a slow, tedious and painstaking task that leads to errors and discrepancies. It is also an expensive process, often taking weeks to properly set up the CMMS, especially maintenance departments with more than three people.

Also, typical users of a CMMS are people who are normally less inclined to use computers or have the patience/desire to use them. Some industry experts state that CMMS installations fail in more than 60% of the cases in large part because of the challenges of setting up the system and database. Furthermore, the staff that is generally expected to enter asset information may not have access to a computer, and often collects information on paper and provides this information to another employee who keys in the data.

The problems identified above may lead to lost productivity, increased downtime, reduced efficiencies and low competitiveness.

There is a need for a resource management platform and also more particularly a maintenance management platform that addresses one or more of the mentioned problems, or at least provides an alternative.

There is a need for a CMMS or application linked to a CMMS that assists in on-boarding of equipment to the CMMS, or at least provides an alternative.

### SUMMARY

In one aspect of the invention, a computer system is provided that is connected to the Internet and enables a plurality of network connected devices to access a novel and innovative resource management platform. The computer system may be implemented as an Internet enabled computer platform that implements a multi-tenant architecture that enables multiple platform clients to populate the platform with various information regarding their resource management requirements.

In one aspect, a computer system for enabling the on-boarding of information regarding one or more physical assets or physical objects to an Internet connected server computer or cloud implemented service, comprising: (A) an on-boarding computer program component, which may be implemented to the server computer and/or a mobile device, the on-boarding computer program component defining one or more utilities that: (i) present to a user (associated with a business) of the mobile device one or more screens that guide the user through capture of one or more information objects that identify an asset or physical object; (ii) optionally enables the user to input additional information regarding the asset or physical object; (iii) transfers the information objects, and optionally the additional information to the server computer; and (iv) the information objects are logged by the server computer, which triggers one or more: (A) automated processes for mapping the information objects to an asset/physical object record in a database linked to the server computer, so as to identify the asset or physical object to the server computer, associated the asset or physical object to the business, and thereby trigger one or more functions or processes of the server computer; and if the automated processes do not meet a mapping threshold (B) the mapping of the information objects is referred to a workflow queue established for one or more human agents to complete the identification of the information objects, associated the asset or physical object to the business, and thereby trigger one or more functions or processes of the server computer.

In another aspect, embodiments described herein may provide a computer system for enabling the on-boarding of information regarding one or more physical assets or physical objects to an Internet connected server computer or cloud implemented service, comprising: a server computer; an on-boarding computer component provided by at least one processor and at least one memory storing executable instructions to configure the on-boarding computer component to: receive, via a mobile device application, one or more captured information objects that provide identification information to identify an asset or physical object; optionally receive additional information regarding the asset or physical object; transfer the information objects, and optionally the additional information to the server computer; and a database linked to the server computer storing asset/physical object records; wherein the server computer is configured to log the information objects which triggers one or more: automated processes for mapping the information objects to an asset/physical object record in the database so as to identify the asset or physical object to the server computer, associate the asset or physical object to an enterprise, and thereby trigger one or more functions or processes of the server computer that rely on the identification information; and if the automated processes do not meet a mapping threshold, referral of the mapping of the information objects to a workflow queue to complete the identification of the information objects, associate the asset or physical object to the enterprise, and thereby trigger one or more functions or processes of the server computer that rely on the identification information.

In some embodiments, the server computer includes or is linked to a computerized maintenance management system (CMMS).

In some embodiments, the server computer is configured to:
identify required information for an asset or physical object;
determine missing information by comparing the required information for the asset or physical object to asset/physical object record;
prompt, via mobile application, for the missing information.

In some embodiments, via on a geographic location received at the mobile application, the server computer is configured to determine that a user is proximate to the asset or physical object the prior to providing the prompt.

In some embodiments, wherein, based on a time, the server computer is configured to determine that a user is proximate to the asset or physical object the prior to providing the prompt.

In some embodiments, the server computer is configured to verify the information objects and optionally the additional information.

In some embodiments, the information objects comprise visual identification information for the asset or physical object.

In some embodiments, the visual identification information comprises at least one photo or image of the asset or physical object, a barcode, a serial number or other aspects of a visual appearance of the asset or physical object.

In some embodiments, the server computer is configured to:
determine an enterprise associated with the information objects;
determine an assets list for the enterprise, wherein the assets list identifies a plurality of assets or physical objects of an enterprise;
perform the mapping of the information objects to an asset/physical object record using the assets list.

In some embodiments, a captured information object is tagged with a location, wherein the server computer is configured to:
maintain a floor plan for the enterprise, wherein the floor plan identifies each asset or physical object of the assets list at a location;
perform the mapping of the information objects to an asset/physical object record using the floor plan and the location tagged to the captured information object.

In some embodiments, the server computer is configured to:
retrieve and provide to the mobile application one or more instructions for identifying asset or physical object more specifically using additional information objects.

In a further aspect, embodiments described herein may provide a method for enabling the on-boarding of information regarding one or more physical assets or physical objects to an Internet connected server computer or cloud implemented service, comprising:
providing an on-boarding computer component using at least one processor;
receiving, at the on-boarding computer via a mobile device application, one or more captured information objects that provide identification information to identify an asset or physical object;
optionally receiving additional information regarding the asset or physical object;
transferring the information objects, and optionally the additional information to a server computer; and
storing asset/physical object records at a database linked to the server computer;
logging, at the server computer, the information objects which triggers:
   mapping of the information objects to an asset/physical object record in the database so as to identify the asset or physical object to the server computer, associate the asset or physical object to an enterprise, and thereby trigger one or more functions or processes of the server computer that rely on the identification information; and
   if a mapping threshold is not met, referring the mapping of the information objects to a workflow queue to complete the identification of the information objects, associate the asset or physical object to the enterprise, and thereby trigger one or more functions or processes of the server computer that rely on the identification information.

In some embodiments, the method may further comprise prompting for the additional information to further identify the asset or physical object more specifically.

In some embodiments, the method may further comprise receiving a general identifier for an asset or physical object; identifying an asset/physical object record using the general identifier; prompting for visual identification information based on the asset/physical object record.

In some embodiments, the method may further comprise identifying required information for an asset or physical object; determining missing information by comparing the required information for the asset or physical object to asset/physical object record; prompting, via mobile application, for the missing information.

In some embodiments, the method may further comprise verifying the information objects and optionally the additional information.

In some embodiments, the method may further comprise determining an enterprise associated with the information objects; determining an assets list for the enterprise, wherein the assets list identifies a plurality of assets or physical objects of an enterprise; performing the mapping of the information objects to an asset/physical object record using the assets list.

In some embodiments, the method may further comprise receiving a location for a captured information object; maintaining a floor plan for the enterprise, wherein the floor plan identifies each asset or physical object of the assets list at a location; performing the mapping of the information objects to an asset/physical object record using the floor plan and the location tagged to the captured information object.

In some embodiments, the method may further comprise retrieving and providing to the mobile application one or more instructions for identifying an asset or physical object more specifically using additional information objects.

In some embodiments, the method may further comprise receiving one or more additional information objects; updating an asset/physical object record using the additional information objects.

In this respect, before explaining at least one embodiment in detail, it is to be understood that embodiments are not limited in its application to the details of construction and to the arrangements of the components set forth in the following description or illustrated in the drawings. Embodiments are capable of other variations and of being practiced and carried out in various ways. Also, it is to be understood that the phraseology and terminology employed herein are for the purpose of description and should not be regarded as limiting.

### BRIEF DESCRIPTION OF THE DRAWINGS

Embodiments will be better understood and aspects will become apparent when consideration is given to the following detailed description thereof. Such description makes reference to the annexed drawings wherein:

FIG. 1 is a system diagram of the maintenance system according to some embodiments;

FIG. 2a shows a screenshot of a representative dashboard interface presented by the server computer program according to some embodiments;

FIG. 2b shows a screenshot of a representative menu interface presented by the server computer program according to some embodiments;

FIG. 2c shows a screenshot of a representative asset interface presented by the server computer program according to some embodiments;

FIG. 2d shows a screenshot of a representative asset interface for adding an asset presented by the server computer program according to some embodiments;

FIG. 2e shows a screenshot of a representative asset interface for a new asset presented by the server computer program according to some embodiments;

FIG. 2f shows a screenshot of a representative photo or image interface presented by the server computer program according to some embodiments;

FIG. 3 illustrates a possible generic computer system implementation according to some embodiments;

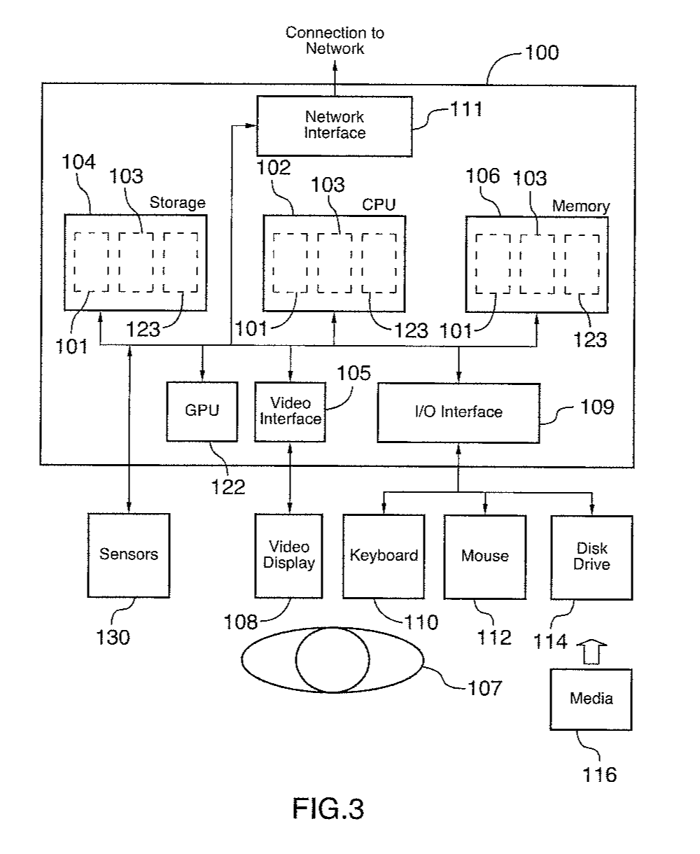

FIG. 4 illustrates a flow chart of a method for on-boarding according to some embodiments.

In the drawings, embodiments are illustrated by way of example. It is to be expressly understood that the description and drawings are only for the purpose of illustration and as an aid to understanding, and are not intended as a definition of the limits.

### DETAILED DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may provide a computer platform that couples to various mobile devices or other computer devices to automate processes for onboarding equipment (e.g. physical assets) to a CMMS. In some embodiments, the platform may integrate with social networking platform. The platform may integrate a cloud based CMMS with collective data sets for linking images of equipment or associated physical object (e.g. a sign on the equipment) to a particular equipment profile (model, year etc.). The improved onboarding process may in turn help streamline the process of assembling information required to input an asset (e.g. equipment) to a CMMS. The equipment may be associated with an enterprise and may be located in a facility for the enterprise. Employees of the enterprise may be busy and manual entry of information may result in errors, be out dated, be limited, and so on. The CMMS may not be valuable if only some of the equipment is onboarded. The platform enables onboarding to be integrating into workflows and systems designed for the maintenance person or other user to be able to walk around the floor, take pictures of equipment, and onboard the equipment iteratively, periodically, and so on.

The platform may maintain a floor plan for different facilities of an enterprise. The floor plan may identify equipment by location, and maintain a profile for each piece of equipment with basic information to identify the category, make, type of equipment etc. but not all of the information. The additional information can be supplied over time while the maintenance person is doing regular usage, checks and so on. The process can be iterative and adaptive in the sense that say through the floor plan (or other way of providing basic information), the system has some idea of what the equipment is and where it is located. This may be explicitly provides or may be inferred from my type of business and some other basic information.

As the person doing the onboarding walks around, the platform could prompt and guide the user. For example, the platform may interact with a mobile interface for prompting directions and questions such as “Are go you use equipment A or equipment B?” The prompt may be based on equipment typically used by this type of business, which may be learned through a cloud collective data set). An administrator or another employee may lay out the basics such as main equipment with make possibly model, but the record or profile may be missing certain information. The prompt may trigger additional inquiries or directions based on the selected equipment. The platform through the interface may prompt: “take picture of name plate of equipment A”. Another example prompt may be “are you headed for machine X? Please take a picture of ABC. If other information is required to positively identify the piece of equipment, this may be identified as well. The platform provides a workflow that will be engaging to the maintenance person, save their time, and make onboarding just part of their normal walkabouts that they do anyways. Way-finding may also be integrated into the platform. Information can be logged iteratively, combined with location tracking of the maintenance person. For example, two pieces of equipment can be pulled in on a first walkabout. The system may know that two other pieces of equipment remain to be onboarded. Prompts may be sent for the maintenance person to complete on-boarding. The prompts may even be triggered when the platform infers that the employee is doing another walkabout within an area of interest (e.g. shop floor). The platform can incorporate a series of rules that are based on strategies for motivating the employee to complete onboarding. Incentives or gamification could be added as well.

The description herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

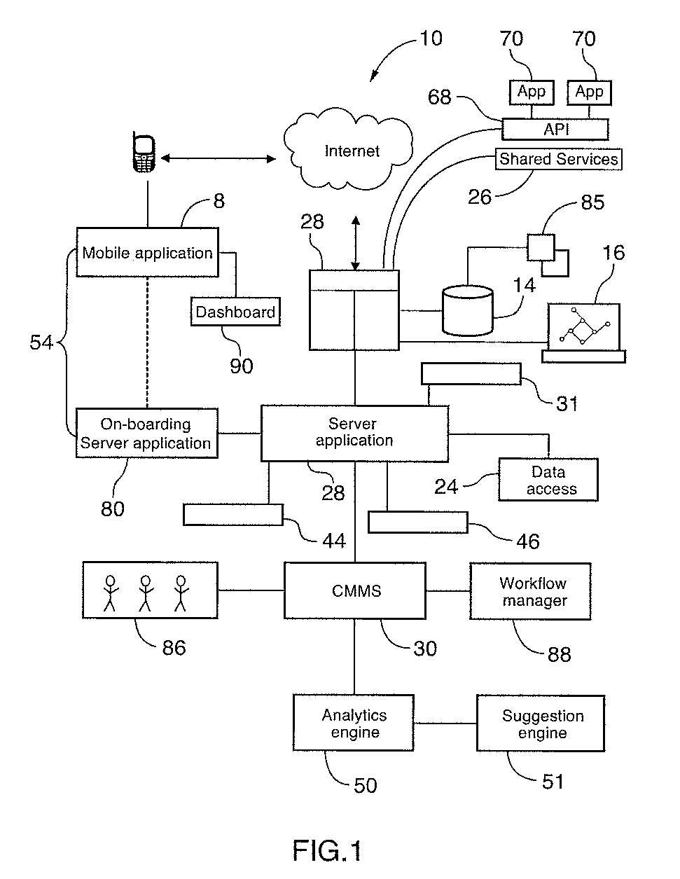

In one aspect, as shown in FIG. 1, a resource management platform (10) is provided. The platform (10) utilizes a multi-tenant architecture that enables multiple platform clients to populate the platform (10) (for example a database (14) associated with the platform (10)) with various information regarding their resource management requirements. The resource management platform (10) includes an on-boarding system (54) or on-boarding service.

The on-boarding system (54) streamlines the population of information required for operation of the resource management platform (10), which may be a CMMS (30). In particular, as described herein, different information is required regarding assets (e.g. equipment) for operation of a CMMS (30). This information is often time consuming or inconvenient to collect. Furthermore, verification of information may be required. Also, information identifying a particular asset may change from time to time, based on changes instituted by the manufacturer for example. Accessing the various functions of a CMMS (30) may require updates to the information. Further details are provided herein.

The on-boarding system (54) may be implemented using a server and data storage devices configured with database(s) or file system(s), or using multiple servers or groups of servers distributed over a wide geographic area and connected via a network. The on-boarding system (54) may be connected to a data storage device directly or via to a cloud based data storage device via network 22. The on-boarding system (54) may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. The data storage devices may be used to provide a persistent store for a user's personal learning record. The on-boarding system (54) may collect and store learning data for a user, index the data for storage, and enable subsequent search and retrieval.

The on-boarding system (54) may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Remote management server 16 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

The on-boarding system (54), in one implementation, includes two principal components: an on-boarding server application (80) and a mobile application (82). The on-boarding server application (80) and the on-boarding mobile application (82) in one implementation are integrated to provide the streamlined CMMS population methods.

The on-boarding mobile application (82) may be implemented in a number of different ways. The on-boarding mobile application (82) (or “mobile application”) may be implemented for example as a mobile client built on any mobile application platform such as iOS™, ANDROID™, WINDOWS™ mobile, or BLACKBERRY™. The mobile application (82) may also be implemented as a mobile web solution wherein mobile device implemented features described herein are implemented by accessing functions of the on-boarding server application (80) using a mobile browser (84).

The mobile application (82) may reside on any networked computing device, such as a personal computer, workstation, server, portable computer, mobile device, personal digital assistant, laptop, tablet, smart phone, WAR phone, an interactive television, video display terminals, gaming consoles, electronic reading device, and portable electronic devices or a combination of these.

The mobile or computing device may include any type of processor, such as, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. The computing device may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

The computing device may include one or more input devices, such as a keyboard, mouse, camera, touch screen and a microphone, and may also include one or more output devices such as a display screen and a speaker. The computing device has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. The mobile application (82) is operable to register and authenticate users (using a login, unique identifier, and password for example) prior to providing access to CMMS 30. The mobile device may be different types of devices and may serve one user or multiple users.

As explained in greater detail below, the mobile application (82) guides a user (who may be associated with a platform client of CMMS (30) through a process for (A) taking one or more pictures of an asset, or parts of the asset to help identify the asset, (B) optionally tagging the pictures (as further explained below), (C) transferring the tagged pictures for identification to an online service for linking the tagged pictures to a unique asset profile (85), and (D) logging the asset to the CMMS (30) such that the asset is linked to the platform client in the CMMS (30). This process may be referred to as the “on-boarding of an asset” or “identification of an asset”.

The linking of the asset with the platform client in the CMMS (30) may trigger various CMMS functions related to the asset based on the unique asset profile (85).

Further details concerning possible mobile implementations of the various embodiments are provided below.

Also, as shown in FIG. 1, the platform (10) may be implemented as a cloud network implemented computer system. The platform (10) may be implemented by a server application (26) or application repository, linked to a server (28) or server farm.

Embodiments may include resource management solutions or platforms other than a CMMS. However, the inventors have discovered that maintenance management is a ubiquitous aspect of enterprise operations, and furthermore one that many incumbent technology suppliers have not addressed in a manner that is satisfactory to many enterprises.

In one implementation, as shown in FIG. 1, the on-boarding system (54) includes or is linked to a web presentment utility (31) that is configured to define an on-boarding hub (86). The on-boarding hub (86) may be made accessible to a plurality of individuals (who may be employees or independent contractors engaged by the operator of the on-boarding system or cloud-based CMMS). The on-boarding hub (86) includes or provides access to one or more utilities that enable these individuals to complete various tasks related to the on-boarding of assets to the CMMS (30). In one aspect, the on-boarding hub (86) is an Internet environment that is accessible to a backend team who performs, if necessary, tasks related to for example mapping of visual content captured by platform clients (such as a business whose premises contain the assets) and more particularly by the personnel of platform clients, to one or more asset lists maintained as part of the CMMS (30). This backend team may be referred to as a “human transcription service” or “HTS”.

As explained below, the on-boarding hub (86) may include or link to various automated utilities or features of the on-boarding system (54). The role of the HTS may involve the logging of pictures of assets to a unique asset profile (85) if the on-boarding server application (80) determines that the automated utilities or features have not resolved the on-boarding of the asset.

In one particular implementation, the HTS team uses the on-boarding hub (86) to add to the information collected using the mobile application (82) for example by storing information provided using the on-boarding process to the database associated with the CMMS (30), under the proper headings or sections in the database. The HTS team may also modify or clean up data where necessary. The HTS team may use one or more known data cleaning tools.

The mobile application (82) may be used to collect various other information that may be relevant to the functions of the CMMS (30).

The HTS team additionally may also search for further associated information of each asset or equipment, such as manuals, preventative maintenance procedures, and so on. This information may be accessed in a number of ways, including by searching on the Internet or by using a data access utility (24) referred to below.

The HTS team allows CMMS setup time and resources to be reduced significantly, and the platform (10) enables this support to be provided in a cost effective manner.

The on-boarding hub (86) may include a workflow manager (88) that assigns on-boarding tasks to the HTS, that may also guide members of the HTS through a variety of steps associated with on-boarding various assets of various platform clients. The on-boarding hub (86) may incorporate various features for managing the activities of the HTS. For example the on-boarding hub (86) may also include a scheduling utility for scheduling the work of the HTS team.

One advantage of the on-boarding system (54) is that, leveraging the CMMS, the platform can gather and populate more data into the CMMS (30), than the user has access to.

Collected information from a number of different applications, through the CMMS (30) is integrated automatically, including with information collected using the on-boarding system (54).

A skilled reader will also understand that the on-boarding of assets using the method disclosed herein may also trigger various functions of the CMMS (30) automatically. For example:

(A) Generation and tracking of maintenance schedules. This may include tracking various maintenance “activities” associated with an asset. For example performing a particular diagnostic operation, or maintenance operation). Activities may be “required” or “recommended”. The platform (10) may be configured to generate reminders and/or calendar entries based on activities. The platform (10) may enable an administrator to assign activities to particular personnel and also send reminders to their mobile phone for example based on user defined parameters.
(B) Executing activities, including on an automated basis. This may include checking an inventory system to see if a part is required for an activity is available, or ordering a part automatically from a supplier. As part of the execution related features, the CMMS (30) may also include supply chain management tools (including order processing and delivery management).

The on-boarding system (54) may be linked to various types of CMMS that incorporate various features. For example, the CMMS (54) may include information sharing between platform clients; a social network enabling social interactions between users that are relevant to maintenance; predictive utilities for anticipating the need for maintenance actions; crowd sourcing of generation of maintenance related information and documents, and so on.

The platform (10) may also link to one or more third party CMMS. In other words, the on-boarding system (54) may be implemented for example as a cloud implemented system that provides services that help streamline the adoption of a plurality of third party CMMS's.

The on-boarding system (54) may be used as part of, or in conjunction with, various systems (and not only CMMS's) where it is desirable to identify assets using information that may be displayed on the asset itself, such as a barcode, a serial number or other identifier, or the aspects of the visual appearance of the asset itself. The on-boarding system (54) provides a streamlined architecture and workflow for capturing visual identification information; sending this to a server or cloud service, and using tools and human resources associated with the server or cloud service populating identification information to a database (also optionally validating the identification information) so as to support features or processes that rely on the identification information.

### Mobile On-Boarding

Further details regarding possible functions and design features for the mobile application (82) are provided.

In one aspect of the implementation, a user simply walks up to one or more assets with their mobile device; and captures information including photos as prompted by the mobile application (82). The captured information may include for example photos of an area shown in one or more images displayed by the mobile application (82) along with possible instructions. For example the images and instructions may assist the user in finding a particular location on an asset where a serial number is normal included on a name plate.

The mobile application (82) may include various smart features for example:

(A) a user provides general information regarding an asset, for example using a menu or window for providing whatever information the user knows about the asset, such as the brand name, its function, and so on;
(B) this information may be analyzed by the mobile application (82), or this information may be sent to the on-boarding server application (80) for analysis;
(C) the mobile application (82) or the on-boarding server application (80) may access a database, and may initiate one or more look up features to find based on the information one or other parameters for confirming generation information regarding the asset;
(D) the results of the look up features may include a string of general identifiers such as “LASER”, “CUTTING”, “MACHINE”;
(C) once one or more general identifiers for the asset have been confirmed, the mobile application (82) may initiate the retrieval and display to the user one or more instructions for finding one or more associated parameters for identifying the asset more specifically;
(D) The mobile application (82) guides the user in providing the desired information, and this is transferred to the on-boarding server (80).

The equipment may be associated with a profile or record with general identification information, as well as the visual identification information (e.g. images equipment or associated physical object), and additional information (model, year, type, etc.). The improved onboarding process may in turn help streamline the process of assembling information required to input an asset (e.g. equipment) to a CMMS. The equipment may be associated with an enterprise and may be located in a facility for the enterprise. The facility may be associated with a floor plan and a list of equipment. Each piece of equipment on the list may be identified by location on the floor plan.

Additional information can be supplied over time while the maintenance person regularly uses, and checks the equipment. The process can be iterative and adaptive in the sense that say through the floor plan (or other way of providing basic information), the system has some idea of what the equipment is and where it is located. This may be explicitly provides or may be inferred from my type of business and some other basic information.

As the person doing the onboarding walks around, the platform could prompt and guide the user. For example, the platform may interact with a mobile interface for prompting directions and questions such as “Are go you use equipment A or equipment B?” The prompt may be based on equipment typically used by this type of business, which may be learned through a cloud collective data set. An administrator or another employee may lay out the basics (general identification) such as equipment make, model, but the record or profile may be missing certain information. The prompt may trigger additional inquiries or directions based on the selected equipment. The platform through the interface may prompt: “take picture of name plate of equipment A”. Another example prompt may be “are you headed for machine X? Please take a picture of ABC”. If other information is required to positively identify the piece of equipment, this may be identified as well. A set of required information may be maintained for each type of equipment. The set of required information may vary.

The platform provides a workflow that will be engaging to the maintenance person, save their time, and make onboarding just part of their normal walkabouts that they do anyways. Way-finding may also be integrated into the platform. Information can be logged iteratively, combined with location tracking of the maintenance person. For example, two pieces of equipment can be pulled in on a first walkabout. The system may know that two other pieces of equipment remain to be onboarded. Prompts may be sent for the maintenance person to complete on-boarding. The prompts may even be triggered when the platform infers that the employee is doing another walkabout within an area of interest (e.g. shop floor). The platform can incorporate a series of rules that are based on strategies for motivating the employee to complete onboarding. Incentives or gamification could be added as well.

In one implementation, the mobile application (82) may include:

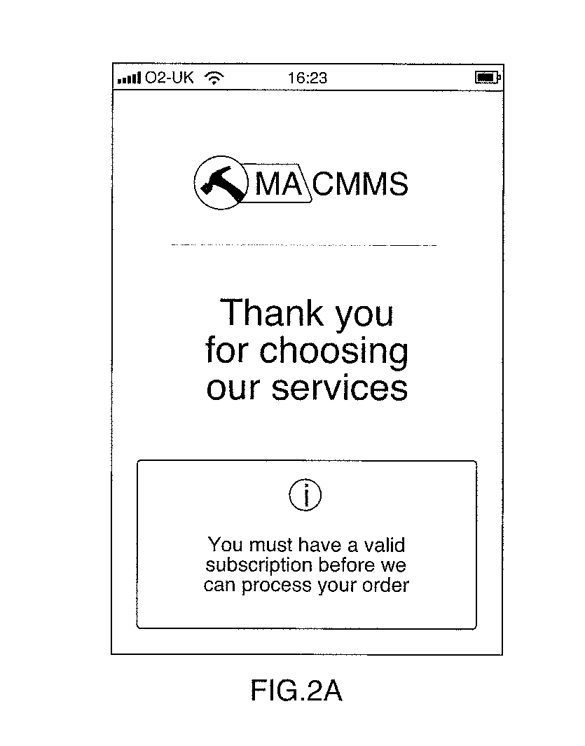

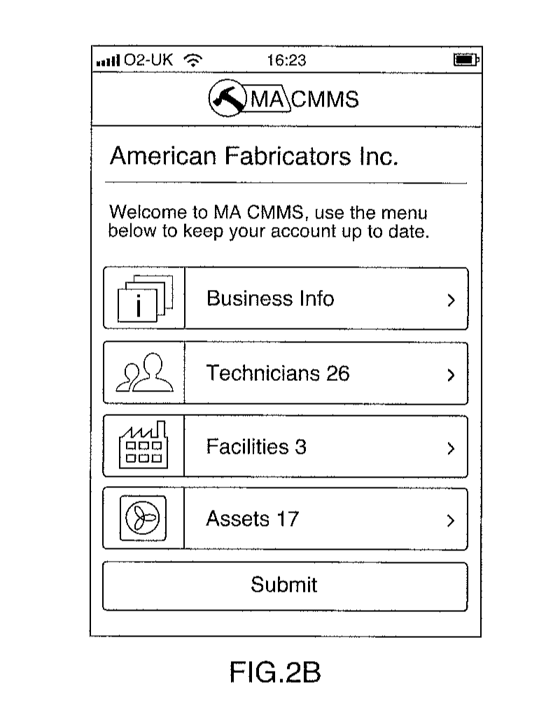

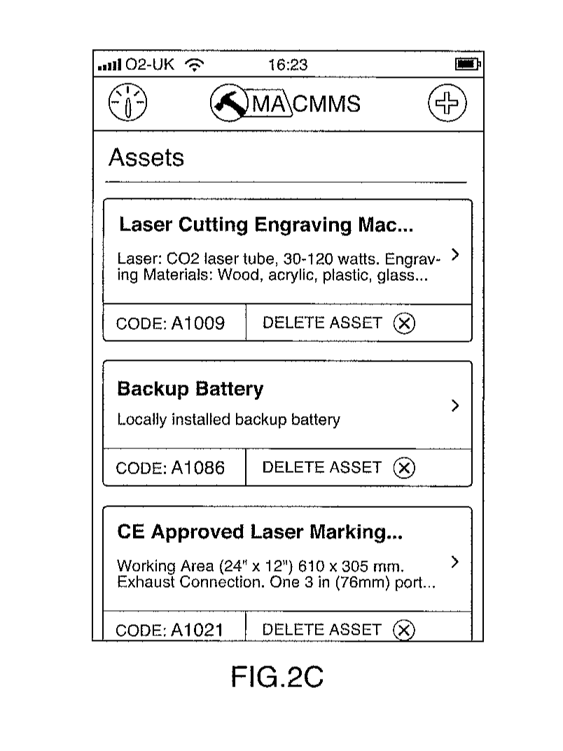

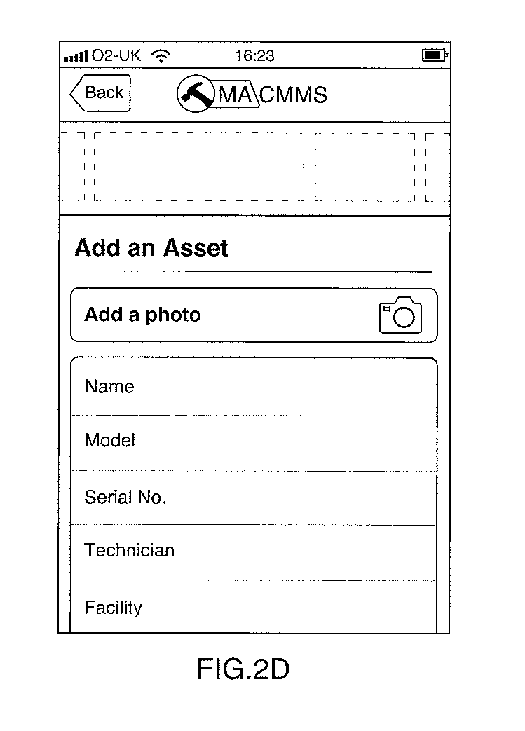

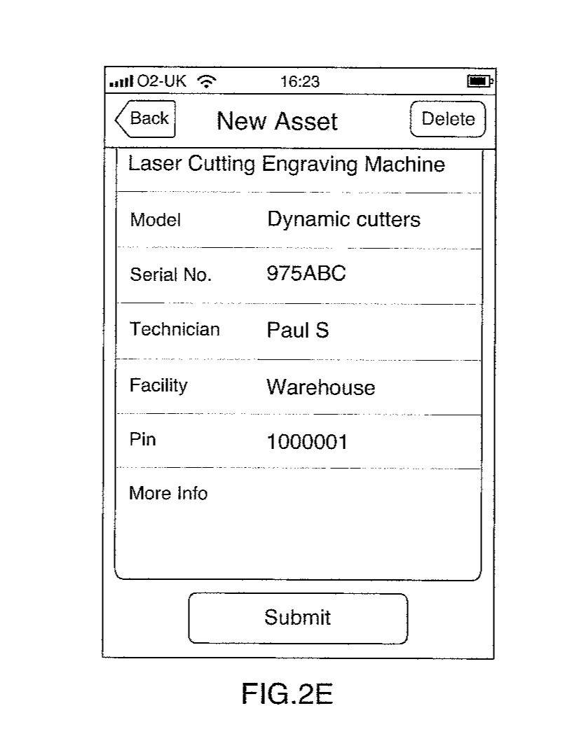

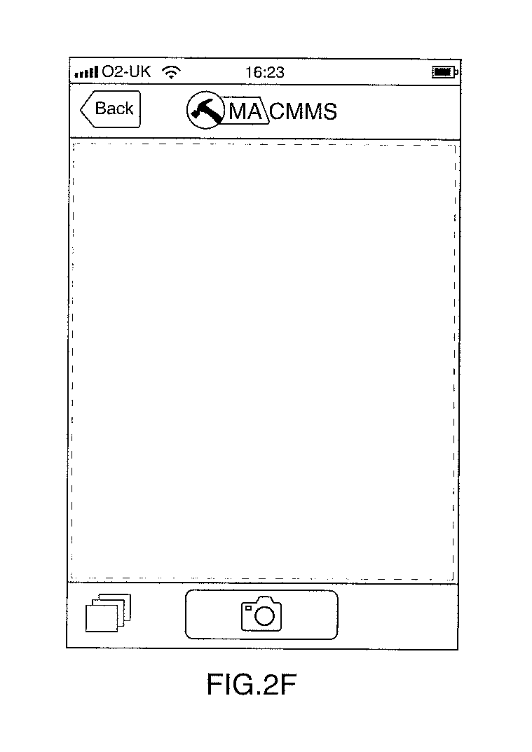

(A) A dashboard (90) that displays various feature or information that a user may access from his/her mobile device. A representative screenshot of a possible dashboard is shown in FIG. 2a.
(B) The dashboard (90) may include a button for accessing an “Assets Listing Page” (92). The dashboard (90) may include a button for accessing a list of assets of a platform client that are already populated to the CMMS (30). The list may be organized based on category, maintenance personnel responsible for them, business group and so on. The dashboard (90) may act as a portal for the user to access various CMMS (30) features using a mobile device. For example, the user may navigate to particular information related to the asset. The user may also delete assets from the CMMS (30) for example using the mobile application (82). A representative screen is shown in FIG. 2a.
(B) a series of “ADD AN ASSET” screens that guide a user through the steps of onboarding an asset to the CMMS (30).

FIGS. 2a-2f show representative interfaces that illustrate possible features of the mobile application (80).

The mobile application (82) and the server application (80) may be configured to synchronize information displayed by the mobile application (82). For example assets being uploaded to the server application (80) by one user, once validated will be shown on an updated asset list on the mobile application (82) of another user. The mobile application (82) may include for example various features for avoiding duplication of work.

The mobile application (82) may use localization and mapping services to populate a map that shows approximate locations of different assets relative to one another in order to assist the user in locating equipment that has not yet been on-boarded. Various other extensions of this functionality are possible, such as creating or uploading a floor plan to a mapping utility that enables the linking of asset information to a map. Maps may be used for example by sending them to service personnel to assist them in finding specific equipment needing servicing.

The mobile application (82) may also enable various information capture or tagging features wherein the user may provide other information relevant to the equipment, including for example reporting as part of on-boarding any problems or observations regarding the equipment. The mobile application (82) may also use the general information referred to above to prompt the user to report whether problems similar to problems logged to the CMMS (30) for the same or similar assets have also been experienced by the user. Various other features are possible.

### Further Intelligent Features

The on-boarding system (54) may also include various other intelligent features.

The platform may include an analytics engine (50). The analytics engine (50) may iteratively: (A) analyze input from the user, (B) compare the information provided through the user to available information (such as a smart asset list) for matches to possible particular assets, (C) initiate the transfer to the mobile application (50) of possible matches or generate questions, designed to lead the user to positive identification of the asset. The analytics engine (50) may incorporate various tools, strategies or algorithms for streamlining this process such as for example semantic analysis operations, matching routines, and next best question scenarios and so on. The on-boarding system (54) may include various technologies and solutions for automating processes, in part or completely, and also for reducing the input required from users.

The on-boarding system (54) may also iteratively capture information regarding specific users that may be used in conjunction with machine learning methods to better interpret input from the user and more effectively identify assets based on this input.

Depending on the information provided by the user, and the information available to the analytics engine (50), a skilled reader will appreciate that the identification of an asset may happen in some cases automatically and in near real time, and without the need to invoke the involvement of the HTS team.

In one aspect, asset information is mapped to a single asset profile despite different nomenclatures, including by operation of the analytics engine (50). The platform also leverages CMMS features that enable the identification and elimination of duplicate asset profiles.

In one implementation, the analytics engine (50) is used to automatically analyze product related information to further improve the asset identification processes. For example, the analytics engine (50) may apply one or more semantic analysis operations to identify product information records that relate to the same information. In one implementation, related records may be identified to an administrator for confirmation.

In another aspect, the platform may include a suggestion engine (51). The suggestion engine (51) may control the particular content displayed by the mobile application (82) to guide the user to completion of the on-boarding processes in an efficient manner.

### Related CMMS Features

In one aspect of the invention, the platform (10) includes a data import utility (44) that is designed to link to online databases made available by manufacturers for example, to extract information required to populate a data record (46) for a particular piece of equipment, as established using the resource profile manager (42). The data record (46), by operation of the platform (10) acts as a unified repository for information concerning a unique piece of equipment. This unique repository inherently avoids duplicate records for the same piece of equipment, and the resulting confusion and inefficiencies.

In one aspect, the platform (10) includes a data access utility (24). In one implementation, the data access utility (24) is used to manage access to various resources of the platform (10) for example by associating an access profile with usernames/passwords associated with a particular platform client. In one aspect of the implementation, the data access utility (24) may be used to configure the shared services (22) made available by the platform (10) on a platform client by platform client basis. In one aspect, the platform (10) is configured to define, through the use of the data access utility (24), a set of rules for establishing the eligibility of a particular platform client to particular shared services (22). For example, platform clients may be required to provide access to information, or agree to share available resources, through the platform (10) with other platform clients in order to access certain shared services (22). This mechanism may be used to motivate platform clients to share information and resources to a greater and greater extent. Conversely, platform clients may retain a certain amount of control over the information/resources that they agree to share through the platform (10). This may be an important feature in driving adoption and usage of the platform (10) in that enterprises may be attracted to the platform (10) but generally wish to first share information/resources in a selected domain, and thereafter if the experience has been positive (for example the benefits are seen to outweigh the perceived risks of engaging with other enterprises through the platform), then generally the platform clients expand their engagement with the platform, which across multiple platform clients is in the interest of the platform clients and also the operator of the platform (10).

In one implementation, the data import utility (44) is configured to automatically extract relevant information or files, and link them to appropriate fields of the applicable data record (42). Alternatively, personnel engaged by the operator of the platform (10) can extract and store this information.

In one aspect, the platform (10) includes or is linked to an on-boarding system (54) that assists users to on-board to the CAMS (30), for example by (A) automating certain on-boarding steps and/or (B) automatically suggesting certain resources or connections available through the platform (10).

### Add-Ons

In one particular implementation of the invention, the platform (10) is implemented using an API (68). The API (68) enables interfaces between the server application (26) and for example third party CMMS's. The API (68) also enables the server application (28) to support applications (70) that may be developed by members of a development community who may be part of the community enabled by the platform (10). The operator of the platform (10) may provide one or more tools that enable developers to develop and launch applications (70) that operate on the platform (10) by means of the API (68).

### Flow Chart

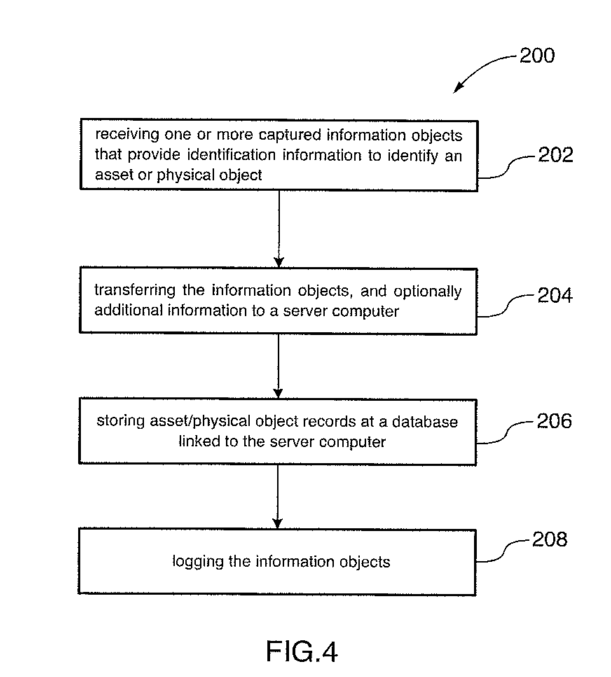

FIG. 4 illustrates a flow chart of a method (200) for on-boarding according to some embodiments.

The method (200) involves providing an on-boarding computer component (54) using at least one processor.

At 202, on-boarding computer component (54) receives via a mobile device application (8), one or more captured information objects that provide identification information to identify an asset or physical object. The information objects may provide general identifiers (type, category, model, year). The information objects may include visual identification information, or visual content such as a barcode, a serial number or other identifier, or the aspects of the visual appearance of the asset itself.

The information objects may be received in response to prompts, instructions, or guides provided at the mobile device application (8). The prompts may be trigger based on missing information for a required information set for each asset. The prompts may also be triggered based on a time parameter, if an employee typically uses a machine or equipment at a particular time, then a prompt for further information about that machine may be provided to facilitate and sync data collection with regular usage. The prompts may also be triggered based on location. The mobile device with mobile device application (8) may include location hardware to detect a current location of the mobile device application (8). This may be mapped to a floor plan identifying the location of various equipment for an enterprise. If the mobile device application (8) is proximate to a particular machine then a prompt may be provided to collect additional identification information for the machine.

At 202, on-boarding computer component (54) may optionally receiving additional information regarding the asset or physical object.

At 204, on-boarding computer component (54) transfers the information objects, and optionally the additional information to a server application (80).

At 206, the information objects, and optionally the additional information is stored as part of asset/physical object records at a database linked to the server computer.

At 208, the server application (80) logs the information objects which triggers: mapping of the information objects to an asset/physical object record in the database so as to identify the asset or physical object to the server computer, associate the asset or physical object to an enterprise, and thereby trigger one or more functions or processes of the server computer that rely on the identification information. If a mapping threshold is not met, referring the mapping of the information objects to a workflow queue to complete the identification of the information objects, associate the asset or physical object to the enterprise, and thereby trigger one or more functions or processes of the server computer that rely on the identification information.

The method may further involve prompting for the additional information to further identify the asset or physical object more specifically. This provides an iterative and continuous approach for on-boarding information.

The method may involve receiving a general identifier for an asset or physical object, then identifying an asset/physical object record using the general identifier. The method may prompt for visual identification information based on the asset/physical object record.

The method may involve receiving identifying required information for an asset or physical object, determining missing information by comparing the required information for the asset or physical object to asset/physical object record, and prompting, via mobile application, for the missing information.

The method may involve receiving verifying the information objects and optionally the additional information.

The method may involve receiving determining an enterprise associated with the information objects, determining an assets list for the enterprise, wherein the assets list identifies a plurality of assets or physical objects of an enterprise, performing the mapping of the information objects to an asset/physical object record using the assets list.

The method may involve receiving a location for a captured information object. The method may involve receiving, maintaining a floor plan for the enterprise, wherein the floor plan identifies each asset or physical object of the assets list at a location, perform the mapping of the information objects to an asset/physical object record using the floor plan and the location tagged to the captured information object.

The method may involve receiving retrieving and providing to the mobile application one or more instructions for identifying an asset or physical object more specifically using additional information objects.

The method may involve receiving one or more additional information objects, and updating an asset/physical object record using the additional information objects.

Accordingly, the on-boarding application (80) is operable determine and prompt for missing information. This prompt may be based on time, location, or other parameter. Additional information may be used to update and modify other information stored in a record to keep it up to date.

Each asset will be associated with a unique asset profile to maintain collection identification information for an enterprise.

The on-boarding application (80) is operable retrieve and display to the user one or more instructions for finding one or more associated parameters for identifying the asset more specifically. The on-boarding application (80) is operable to support features or processes that rely on the identification information. The on-boarding application (80) is operable map of visual content to assets of asset lists for an enterprise. The on-boarding application (80) is operable assign tasks to different users to capture additional information based on regular work flow. The on-boarding application (80) is operable to prompt with reference to a scheduling utility to determine when maintenance will be performed and capture associated data. The on-boarding application (80) is operable link to maintenance schedules for maintenance activities to capture prompts. The on-boarding application (80) is operable to tag captured information with date, location, user identifier, and other meta data.

The equipment may be associated with an enterprise and may be located in a facility for the enterprise. Employees of the enterprise may be busy and manual entry of information may result in errors, be out dated, be limited, and so on. The on-boarding application (80) enables onboarding to be integrating into workflows and systems designed for the maintenance person or other user to be able to walk around the floor, take pictures of equipment, and onboard the equipment iteratively, periodically, and so on. The on-boarding application (80) is operable to automatically map the captured data to the unique asset profiles.

The platform may maintain a floor plan for different facilities of an enterprise. The floor plan may identify equipment by location, and maintain a profile for each piece of equipment with basic information to identify the category, make, type of equipment (e.g. general identification information) but not all of the information (e.g. visual identification information). The additional information can be supplied over time while the maintenance person is doing regular usage, checks and so on. The process can be iterative and adaptive in the sense that say through the floor plan (or other way of providing basic information), the system has some idea of what the equipment is and where it is located. This may be explicitly provides or may be inferred from my type of business and some other basic information.

As the person doing the onboarding walks around, the platform could prompt and guide the user. For example, the platform may interact with a mobile interface for prompting directions and questions such as “Are go you use equipment A or equipment B?” The prompt may be based on equipment typically used by this type of business, which may be learned through a cloud collective data set). An administrator or another employee may lay out the basics such as main equipment with make possibly model, but the record or profile may be missing certain information. The prompt may trigger additional inquiries or directions based on the selected equipment. The platform through the interface may prompt: “take picture of name plate of equipment A”. Another example prompt may be “are you headed for machine X? Please take a picture of ABC”. If other information is required to positively identify the piece of equipment, this may be identified as well. The on-boarding application (80) is operable implement way-finding. Information can be logged iteratively, combined with location tracking of the maintenance person. For example, two pieces of equipment can be pulled in on a first walkabout. The on-boarding application (80) is operable to know that two other pieces of equipment remain to be onboarded. Prompts may be sent for the maintenance person to complete on-boarding. The prompts may even be triggered when the platform infers that the employee is doing another walkabout within an area of interest (e.g. shop floor). The platform can incorporate a series of rules that are based on strategies for motivating the employee to complete onboarding. Incentives or gamification could be added as well.

### Example in Operation

The operation of the invention may be illustrated in a use case. Embodiments are not limited to the particular embodiments or method described in the illustrative example.

An example enterprise may be “Acme Co” which may be a platform client of CMMS (30). Acme Co has many production lines, and thus lots of assets, equipment, parts, etc.

The maintenance department of Acme has never used a CMMS before, or spreadsheets for that matter, all of their records and information are on paper. This represents a daunting task to manually input this data into the CMMS. In the past, this heavy burden may deter all but the most persistent person, and even then the required time, effort and cost would be significant.

CMMS (30), however, includes or is linked to the on-boarding system (54) which includes the mobile application (82), and associated workflow. The described technology makes even significant CMMS deployments manageable, and in only a fraction of the time with minimal effort. Once the user installs the mobile application (82) on their smart phone or tablet computer, the maintenance user begins to walk around the plant taking pictures (e.g. visual identification information) of all the equipment, parts and assets from their mobile device. In addition, the user takes pictures of items with identifying information such as name plates that bear the machine make, model and serial numbers. The mobile application (82) organizes how and when pictures are taken and properly records the resulting images and information together with identifying tags and sends this to the user's cloud based CMMS (30), in one implementation.

Once the user completes walking about the plant and taking pictures, the mobile application (82) finishes and all information is uploaded to the cloud. A team of remote CMMS and software experts, who may be associated with the operator of the cloud based CMMS (30), access the information and begin to verify the information, and ensure that it is stored properly in a database associated with the CMMS (for example a set of rules may determine the proper storage of asset information in particular locations, and with the right headings and correct categorization, in order to enable various data driven CMMS functions).

The operator of the CMMS may define one or more rules or processes, and provide certain tools (which may be integrated with the CMMS) for cleaning data, and obtaining useful information that is related to the asset information, and linking this to the asset information in the database. The images may be processed to automatically extract information therein. This may include relevant information in data stores linked to the CMMS. Also the HTS team may scrape the Internet or use data acquisition tools for obtaining relevant information, which may also be associated with the asset information.

Once complete, the HTS team may send notification to the user that the CMMS system and database has been fully setup, upgraded and handed over, and ready for the immediate use by the platform client. The entire implementation process has been mostly taken out of the hands of the customer, relieving him of a significant burden and pain, while significantly improving their on-boarding experience and chances of long term success with the CMMS.

Moreover, an expanding database of asset information is continually created by the aggregate efforts of both CMMS users and the HTS team. In one implementation of the CMMS, there may be crowd sources or social aspects that enable the generation of additional relevant information that may be used to further enrich available asset information. Over time, this dynamically updated database, which may be curated and operated by the operator of the CMMS, in one implementation, is leveraged to further assist in improving a user's CMMS onboarding experience by being able to offer further time-and-effort saving features, such as recommendations of, or even auto-populating, complete and updated records of equipment data for the asset that a user has as s/he populates or modifies the CMMS database.

Thus, in time, the on-boarding and long term use experience of the customer improves even further, and may reduce the dependency on the HIS team to perform many of the actions or services.

### Social Networking Environment

In this disclosure, by “social networking platform” (16) means any computer network implemented application platform that is operable to generate a series of web pages so as to define a series of user interactions and/or workflows, including social media interactions, that define a social networking environment.

“Friends” refers to two or more users of a social networking platform who share one or more social interaction privileges by operation of the social networking platform, based on one or more pre-established rules. Conferring the social interaction privileges may require user acceptance and/or may be assigned automatically by the social networking platform based on the rules.

“Social media interactions” refer to the various interactions between users of a social networking platform (including “friends”), the interactions including various communications (such as platform messaging, instant messaging, videoconferencing, voice messaging, etc.), uploading or posting content in one or more media, downloading content in one or more media, watching content in one or more media, reviewing or rating content including “objects”, taking a quiz, selling or trading items such as “objects”, and so on.

“Objects” include any content or media object that may be used or consumed in connection with social interactions, such as for example a social feed, a message, a use case, a video, quiz, a tip, a discussion, a digital good, etc.

The social networking environment should be understood to include conventional known social networking aspects but departs from the prior art by incorporating these into a resource management or maintenance management related platform, with on-boarding functionality. The social media interactions relate to community interactions around sharing of information and resources through a web enabled platform.

Certain possible attributes of the social networking platform (16) are described. The web presentment utility (31) is operable to generate a series of web pages, as directed by the social networking platform (16) so as to define a series of user interactions and/or workflows, including social interactions that define the social networking environment described herein.

The present invention enables the connection of two or more personnel (across enterprise locations or across different businesses such as manufacturer-distributor-retailer) that may not have otherwise met yet together represent a combination of access to information, expertise, local knowledge, maintenance knowledge, equipment knowledge, or other facts that, when brought together within a social networking platform that enables cost effective, familiar and engaging social interactions, can provide and create synergistic value around important resource management objectives having a shared benefit across two or more platform clients. This may facilitate group or social on-boarding by the sharing of identification information captured for equipment.

The social networking platform (16) may be used to implement a variety of social media interactions that promote objectives of the platform (10). For example, social media interactions between users may be initiated so as to (A) identify users engaged in similar activities, such as maintaining similar equipment, or indicating a similar knowledge base, (B) suggest that such users “friend” one another through the social networking platform (16), (C) enable communications and social media interactions between “friended” users, and/or (D) encourage users in social networks to provide one another a “knowledge rating” in one or more particular domains. The analytics engine (50) may be configured to aggregated knowledge ratings for users, and optionally using other metrics, calculate a “knowledge score” or equivalent for relevant users. Knowledge scores may be associated with incentives, and also enable the operator of the platform (10) to target users who meet certain knowledge score thresholds for example to review information or prepare documents (such as service manual addenda) for dissemination and use through the platform (10).

The platform may attract users who may have specialized and valuable knowledge, but which is not used outside of their organization, and linking these users with one another that enables dissemination of knowledge and expertise, thereby improving productivity of participating organizations as a whole.

[The system and method of the present invention is operable to distribute knowledge in order to improve maintenance related outcomes to a group of platform clients.

The social networking platform (16) may be generally implemented using one or more application servers. For example, the social networking platform (16) system that may include an application server and graph servers. The application server manages a member database, a relationship database, and a search database. The application server may also contain a matching engine to enable the suggestion of friend combinations based on a series of criteria. Friend suggestions may require acceptance, after which they are added to relevant social graphs managed using the graph server. The matching engine may suggest friend matches based on criteria such as similarity of industry, but filtering matches between competing organization established for example based on user defined competitors lists. The matching engine may include various functions or features for matching individuals based on a variety of criteria including for example demographic attributes, personality traits, and also factors related to the enterprise objectives. For example the matching engine may be used to match friends within groups defined by the social networking environment based on similarity or dissimilarity (depending on for example campaign objectives) of experience, training, maintenance certificates and so on. Matching may also be based on attributes associated with for example the retail stores in which users may operate. For example, users may be matched with users who work at similar businesses or maintain similar equipment. The purpose of matching user 1 with user 2 may be to enable user 2 to share tips with user 1 in an engaging atmosphere that both user 1 and user 2 are familiar. The social interactions enabled by the social networking platform (16) provide an informal setting for user 1 and user 2 to socialize and in the process share tips regarding maintenance.

The social networking platform (16) may also be configured to implement a number of community interactions, and also activities initiated by the operator of the platform (10) such as crowd sourcing of activities that add value to the platform (10). In one example, the social networking platform (16) may be used to create and promote projects related to the translation of content associated with the platform (16). In one possible implementation of the invention, the platform (10) includes a managed crowd sourcing system that enables the operator or one or more of the platform clients to design a campaign to provide incentives to other users to translate content. For example, a manufacturer or a distributor may provide incentives through the platform (16) to platform clients or their personnel to create translations of technical information related to their products. Translations may be distributed through the platform (10) based on a number of different monetization models or incentive models that may be supported by the platform (10).

The on-boarding system (54) tracks partial information provided by a user, for example in filling out a form that is part of the equipment list being completed by the user. The partial information is compared to the available data records (46) to find one or more matches, and if a match is found auto-populates one or more fields of the form with relevant information from the matched data record (46), or provides a list of close matches for user selection. Also, the on-boarding system (54) may invoke the analytics engine (50) to analyze information provided by the platform client (12) or related to the platform client (12), such as the equipment list, but also information concerning the platform client (12) that may be stored to a platform client profile (56). This information may be used to find for example maintenance documents of interest to the platform client user. This information may also be used to initiate social media interactions with users with similar maintenance responsibilities by operation of the social networking platform (16) subject to permissions established by the platform client.

It should be understood that the social networking platform (16) may be used to suggest friend connections, for users to friend one another based on common interest (for example similar responsibilities, issues with similar equipment and so on). The power of the social web is leveraged by the platform (10) in order to enable users to connect with one another to form (one on one and group) connections based on maintenance issues and required onboarding data. The platform (10) enables connections to be made between people requiring information and those willing to provide it (including by operation of the incentives embodied in the system), thus disseminating information in an efficient way that may not have been available through any means before.

Generally speaking, most platform clients (12) will want to keep information concerning their maintenance, equipment, and operations anonymous, or at least inaccessible to competitors. For example, Platform Client A will not want its competitor to know that it is having trouble getting a key piece of equipment to work. Or alternatively, Platform Client A does not want to expose itself to raiding of key resources who contribute to much better than average performance of another key piece of equipment. Therefore in one aspect of the invention, platform clients (for example an administrator) may filter the availability of certain information and otherwise mediate social media interactions if this is desired.

In one particular aspect of the implementation of the invention, the platform (10) may include a content delivery platform that enables content to be made available through the platform (10) to a wide variety of network connected devices, in a wide variety of formats and media. For example the content delivery platform may be used to format how-to guides submitted by users so that they are available using a mobile device.

Content may be rated by users and then promoted through the platform based on relevance. Recommended content may result in triggering of incentives by operation of the incentive platform.

The platform (10) also may include a messaging utility that enables users to share information or collaborate with colleagues or friends established using the social networking features of the social networking platform (16) (for example users may select as friends in their network established through the platform (10) only those individuals that they are comfortable or are not with a competing organization for example. The messaging utility may be utilized to send in-platform messages to the user's network through the platform (10) with a question as to who may have relevant onboarding data.

### Incentive System

An incentive platform (not shown) enables a variety of incentives to encourage desired behaviours from different users of the platform. For example, loyalty points or badges may be associated with enhancement of data records (46) or correction of data records (46) or submitting a new maintenance list or best practices document or video.

The incentive platform may also incorporate various gamification processes for encouraging users to share information or resources.

In one aspect of a possible implementation of the invention, platform clients may receive discounts in the normally applicable commissions for example based on a contribution score defined for them by operation of the analytics engine (50).

### General Implementation

It should be understood that the present disclosure may explain the invention by reference to a number of example implementations that describe certain functionality being implemented by the mobile application (82) and other functionality being implemented by the server application (80). It should be understood that various of these features associated in the disclosure with the mobile application (82) may also be implemented by the server application (80), or alternatively features associated in the disclosure with the server application (80) may be implemented by the mobile application (82). As a still other alternative, some features may be implemented on a distributed basis with some operations occurring on the mobile device and others on the server side. A skilled reader will understand that various implementations and system and network architectures are possible.

It should also be understood that the server (20) may be implemented as one or more servers in any possible server architecture or configuration including for example in a distributed server architecture, a server farm, or a cloud based computing environment.

It will be appreciated that any module or component exemplified herein that executes instructions may include or otherwise have access to computer readable media such as storage media, computer storage media, or data storage devices (removable and/or non-removable) such as, for example, magnetic disks, optical disks, tape, and other forms of computer readable media. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD), blue-ray disks, or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10, tracking module 30, object tracking application 34, etc., or accessible or connectable thereto. Any application or module herein described may be implemented using computer readable/executable instructions that may be stored or otherwise held by such computer readable media.

A skilled reader will recognize that other example various extensions to the features and functions described are possible, such as incorporating semantic analysis functions to the system so as to minimize the data entry required by users of the mobile application (82).

It will also be appreciated that the block configurations, screen shots, and flow charts provided herein are for illustrative purposes only and various modifications thereof are applicable within the principles discussed herein.

The present system and method may be practiced on virtually any manner of computer device, however, the advantages described are realized especially in connection with any form of portable network-connected device including a laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

As stated earlier, the mobile application (82) of the present invention may be implemented as a web service, where the mobile device includes a link for accessing the web service, rather than a native application. Also, the functionality described may be implemented to any mobile platform, including the iOS platform, ANDROID™, WINDOWS™ or BLACKBERRY™.

Although the above principles have been described with reference to certain specific embodiments, various modifications thereof will be apparent to those skilled in the art without departing from the scope of the invention and the claims appended hereto. Other modifications are therefore possible.

### ADVANTAGES

Various advantages of embodiments described herein have already been mentioned above. Further advantages are described below, including the following non-limiting examples:

A unique and innovative CMMS offering.
An innovative platform is provided that may be linked to a CMMS or made part of a CMMS platform that improves ease of adoption.
An on-boarding system that streamlines and automates aspects of population of important asset information to a CMMS.
An on-boarding system for a CMMS that is cost effective and easy to use.
A system that ensures that a CMMS is set up properly and therefore provides higher user satisfaction, and improve usage of the CMMS with its various improvements to business operations.
A CMMS incorporating an innovative mobile layer that streamlines on-boarding and also leverages intelligent features by connecting to one or more cloud implemented utilities.
A web based platform that is accessible from many different devices, including smart phones and tablets, and provides easy access to maintenance related information and activities through a single, intuitive interface, thus replacing costly and inconvenient paper processes and/or multiple technologies used for the same functions.
A platform that includes a mobile application that guides users through on-boarding steps and pushes time consuming data entry to cloud based services, including manual transcription resources and intelligent features that leverage rich asset related information associated with a cloud based CMMS platform.

1. A computer system for enabling the on-boarding of information regarding one or more physical assets or physical objects to an Internet connected server computer or cloud implemented service, comprising:
a server computer;
an on-boarding computer component provided by at least one processor and at least one memory storing executable instructions to configure the on-boarding computer component to:
receive, via a mobile device application, one or more captured information objects that provide identification information to identify an asset or physical object;
optionally receive additional information regarding the asset or physical object;
transfer the information objects, and optionally the additional information to the server computer; and
a database linked to the server computer storing asset/physical object records;
wherein the server computer is configured to log the information objects which triggers one or more:
automated processes for mapping the information objects to an asset/physical object record in the database so as to identify the asset or physical object to the server computer, associate the asset or physical object to an enterprise, and thereby trigger one or more functions or processes of the server computer that rely on the identification information; and
if the automated processes do not meet a mapping threshold, referral of the mapping of the information objects to a workflow queue to complete the identification of the information objects, associate the asset or physical object to the enterprise, and thereby trigger one or more functions or processes of the server computer that rely on the identification information.

2. The computer system of claim 1, wherein server computer includes or is linked to a computerized maintenance management system (CMMS).

3. The computer system of claim 1, wherein the server computer is configured to:
identify required information for an asset or physical object;
determine missing information by comparing the required information for the asset or physical object to asset/physical object record;
prompt, via mobile application, for the missing information.

4. The computer system of claim 3, wherein, via on a geographic location received at the mobile application, the server computer is configured to determine that a user is proximate to the asset or physical object the prior to providing the prompt.

5. The computer system of claim 3, wherein, based on a time, the server computer is configured to determine that a user is proximate to the asset or physical object the prior to providing the prompt.

6. The computer system of claim 1, wherein server computer is configured to verify the information objects and optionally the additional information.

7. The computer system of claim 1, wherein the information objects comprise visual identification information for the asset or physical object.

8. The computer system of claim, wherein the visual identification information comprises at least one photo or image of the asset or physical object, a barcode, a serial number or other aspects of a visual appearance of the asset or physical object.

9. The computer system of claim 1, wherein the server computer is configured to:
determine an enterprise associated with the information objects;
determine an assets list for the enterprise, wherein the assets list identifies a plurality of assets or physical objects of an enterprise;
perform the mapping of the information objects to an asset/physical object record using the assets list.

10. The computer system of claim 9, wherein a captured information object is tagged with a location, wherein the server computer is configured to:
maintain a floor plan for the enterprise, wherein the floor plan identifies each asset or physical object of the assets list at a location;
perform the mapping of the information objects to an asset/physical object record using the floor plan and the location tagged to the captured information object.

11. The computer system of claim 1, wherein the server computer is configured to:
retrieve and provide to the mobile application one or more instructions for identifying asset or physical object more specifically using additional information objects.

12. A method for enabling the on-boarding of information regarding one or more physical assets or physical objects to an Internet connected server computer or cloud implemented service, comprising:
providing an on-boarding computer component using at least one processor;
receiving, at the on-boarding computer via a mobile device application, one or more captured information objects that provide identification information to identify an asset or physical object;
optionally receiving additional information regarding the asset or physical object;
transferring the information objects, and optionally the additional information to a server computer; and
storing asset/physical object records at a database linked to the server computer;
logging, at the server computer, the information objects which triggers:
mapping of the information objects to an asset/physical object record in the database so as to identify the asset or physical object to the server computer, associate the asset or physical object to an enterprise, and thereby trigger one or more functions or processes of the server computer that rely on the identification information; and
if a mapping threshold is not met, referring the mapping of the information objects to a workflow queue to complete the identification of the information objects, associate the asset or physical object to the enterprise, and thereby trigger one or more functions or processes of the server computer that rely on the identification information.

13. The method of claim 12, further comprising: prompting for the additional information to further identify the asset or physical object more specifically.

14. The method of claim 12 further comprising:
receiving a general identifier for an asset or physical object;
identifying an asset/physical object record using the general identifier;
prompting for visual identification information based on the asset/physical object record.

15. The method of claim 12 further comprising:
identifying required information for an asset or physical object;
determining missing information by comparing the required information for the asset or physical object to asset/physical object record;
prompting, via mobile application, for the missing information.

16. The method of claim 12 further comprising:
verifying the information objects and optionally the additional information.

17. The method of claim 12 further comprising:
determining an enterprise associated with the information objects;
determining an assets list for the enterprise, wherein the assets list identifies a plurality of assets or physical objects of an enterprise;
performing the mapping of the information objects to an asset/physical object record using the assets list.

18. The method of claim 17 further comprising:
receiving a location for a captured information object;
maintaining a floor plan for the enterprise, wherein the floor plan identifies each asset or physical object of the assets list at a location;
perform the mapping of the information objects to an asset/physical object record using the floor plan and the location tagged to the captured information object.

19. The method of claim 12 further comprising:
retrieving and providing to the mobile application one or more instructions for identifying an asset or physical object more specifically using additional information objects.

20. The method of claim 12 further comprising:
receiving one or more additional information objects;
updating an asset/physical object record using the additional information objects.
